(19) United States
(12) Patent Application Publication
(10) Pub. No.: US 2025/0148031 A1
(43) Pub. Date: May 8, 2025

(54) ARTIFICIAL INTELLIGENCE BASED (AI-BASED) SYSTEM AND METHOD FOR GENERATING NEWS ARTICLES IN A BLOCKCHAIN ECOSYSTEM

(71) Applicant: ChainGPT LLC, Dover, DE (US)

(72) Inventor: Ilan Rakhmanov, Dover, DE (US)

(21) Appl. No.: 18/939,662

(22) Filed: Nov. 7, 2024

Related U.S. Application Data
(60) Provisional application No. 63/596,981, filed on Nov. 8, 2023.

(51) Int. Cl. G06F 16/9538; G06F 16/906; G06F 16/951; G06F 16/9535; G06T 11/00

(52) U.S. Cl. CPC G06F 16/9538; G06F 16/906; G06F 16/951; G06F 16/9535; G06T 11/00

(57) ABSTRACT

An AI-based system and method for generating news articles in a blockchain ecosystem, is disclosed. The AI-based method includes obtaining data associated with the news articles from data sources on news publishing platforms; clustering the data associated with the news articles based on similarity of the data associated with the news articles, using an AI model; categorizing the clustered data associated with the news articles, into pre-defined categories, using the AI model; summarizing the categorized data associated with the news articles by rephrasing and generating concise and coherent summaries of the categorized data associated with the news articles, using the AI model; generating images corresponding to the summarized data associated with the news articles, using a stable diffusion model; and providing the summarized data associated with the news articles along with corresponding images, as an output, to users through user interfaces associated with communication devices of the users.

### CROSS REFERENCE TO RELATED APPLICATION(S)

This application claims the priority to and incorporates by reference the entire disclosure of U.S. provisional patent application bearing No. 63/596,981 filed on Nov. 8, 2023, titled “SYSTEM FOR OPTIMIZING MULTI-FACETED BLOCKCHAIN ECOSYSTEM AND METHOD THEREOF”

### TECHNICAL FIELD

Embodiments of the present disclosure relate to blockchain technology, and more particularly relate to an artificial intelligence based (AI-based) system for generating one or more news articles in multi-faceted blockchain ecosystem by leveraging artificial intelligence (AI) and data analysis techniques to streamline processes, improve security, and make blockchain technology more accessible to a diverse user base.

### BACKGROUND

Blockchain technology has gained significant prominence as a decentralized and secure digital ledger system. The blockchain technology underpins various applications, including news aggregation, cryptocurrencies, digital contracts, non-fungible tokens (NFTs), and decentralized finance (DeFi). The distributed nature of blockchain technology ensures transparency and trust among participants, making blockchain technology a cornerstone of innovation in numerous industries.

Despite the considerable potential of blockchain technology, it presents challenges for mainstream adoption. For instance, digital contract development demands proficiency in blockchain-specific languages like Solidity, creating a barrier to entry for non-developers and impeding the swift deployment of blockchain solutions. Furthermore, ensuring the security and integrity of digital contracts is of paramount importance, as vulnerabilities result in severe and catastrophic consequences.

Additionally, the realm of cryptocurrency landscapes is characterized by instability and complexity, creating hurdles for both investors and enthusiasts seeking to navigate this cryptocurrency landscape. While the cryptocurrency landscape is vital to stay informed about cryptocurrency trends and market data, accomplishing this often requires a significant investment of time and expertise.

Moreover, the rise of NFTs has brought about a new and distinctive digital asset category. However, the creation and management of NFTs generally entail proficiency in coding and a deep understanding of blockchain technology. In addition to the challenges in blockchain technology and cryptocurrency management, staying up to date with the rapidly evolving world of blockchain technology and digital currencies is crucial for informed decision-making. The proliferation of news and information on the internet overwhelms individuals seeking reliable and relevant updates on blockchain, cryptocurrencies, and related technologies.

There are various technical problems with blockchain technology in the prior art. These technical problems encompass complexities related to digital contract development, which demand expertise in blockchain-specific languages and pose barriers for non-developers. Additionally, the security and integrity of digital contracts present ongoing concerns, as vulnerabilities have severe consequences. The cryptocurrency landscape is marked by volatility and intricacies, making it challenging for investors and enthusiasts to navigate and stay informed about market trends. Moreover, the emergence of NFTs has introduced a unique digital asset class, but the process of creating and managing NFTs typically involves specialized coding skills and blockchain knowledge.

Therefore, there is a need for a system to address the aforementioned issues by providing am AI-based system and method to streamline blockchain processes, enhance security, simplify digital contract development, automate NFT management, offer insights into cryptocurrency trends, and facilitate efficient news aggregation.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence based (AI-based) method for generating one or more news articles in a blockchain ecosystem, is disclosed. The AI-based method includes obtaining, by one or more hardware processors, data associated with the one or more news articles from one or more data sources on one or more news publishing platforms. The AI-based method further includes clustering, by the one or more hardware processors, the data associated with the one or more news articles based on similarity of the data associated with the one or more news articles, using an artificial intelligence (AI) model. The AI-based method further includes categorizing, by the one or more hardware processors, the clustered data associated with the one or more news articles, into one or more pre-defined categories, using the AI model.

The AI-based method further includes summarizing, by the one or more hardware processors, the categorized data associated with the one or more news articles by rephrasing and generating concise and coherent summaries of the categorized data associated with the one or more news articles, using the AI model. The AI-based method further includes generating, by the one or more hardware processors, one or more images corresponding to the summarized data associated with the one or more news articles, using a stable diffusion model. The AI-based method further includes providing, by the one or more hardware processors, the summarized data associated with the one or more news articles along with the corresponding one or more images, as an output, to one or more users through one or more user interfaces associated with one or more communication devices of the one or more users.

In an embodiment, clustering the data associated with the one or more news articles based on the similarity of the data associated with the one or more news articles, comprises: (a) obtaining, by the one or more hardware processors, the data associated with the one or more news articles from a data scraping subsystem; (b) generating, by the one or more hardware processors, one or more vector embeddings for the data associated with each news article of the one or more news articles, using an embedding model, wherein the one or more vector embeddings are configured to determine one or more semantic meanings of one or more texts associated with the one or more news articles; (c) determining, by the one or more hardware processors, one or more cosine similarities between the one or more vector embeddings generated for the data associated with the one or more news articles, using a cosine similarity model; (d) determining, by the one or more hardware processors, one or more similarity scores based on the determined one or more cosine similarities between the one or more vector embeddings generated for the data associated with the one or more news articles; and (e) clustering, by the one or more hardware processors, the data associated with the one or more news articles based on the one or more similarity scores.

In another embodiment, categorizing the clustered data associated with the one or more news articles, into the one or more pre-defined categories, using the AI model, comprises: (a) obtaining, by the one or more hardware processors, the clustered data associated with the one or more news articles, from a data clustering subsystem; (b) comparing, by the one or more hardware processors, one or more patterns of the clustered data associated with the one or more news articles with one or more pre-defined patterns of pre-defined data associated with one or more pre-defined news articles being stored in one or more databases, using the AI model; and (c) categorizing, by the one or more hardware processors, the clustered data associated with the one or more news articles, into the one or more pre-defined categories upon comparison of the one or more patterns of the clustered data associated with the one or more news articles with the one or more pre-defined patterns of the pre-defined data associated with the one or more pre-defined news articles being stored in one or more databases.

In yet another embodiment, the AI-based method further includes (a) training, by the one or more hardware processors, the stable diffusion model on one or more training datasets, wherein the one or more training datasets comprise at least one of: one or more crypto-related images and one or more text descriptions corresponding to the one or more crypto-related images; and (b) generating, by the one or more hardware processors, the one or more images corresponding to the summarized data associated with the one or more news articles, based on the trained stable diffusion model.

In one aspect, an artificial intelligence based (AI-based) system for generating one or more news articles in a blockchain ecosystem. The AI-based system includes one or more hardware processors. The AI-based system further includes a memory coupled to the one or more hardware processors, wherein the memory comprises a plurality of subsystems in form of programmable instructions executable by the one or more hardware processors. The plurality of subsystems comprises a data scraping subsystem configured to obtain data associated with the one or more news articles from one or more data sources on one or more news publishing platforms.

The plurality of subsystems further comprises a data clustering subsystem configured to cluster the data associated with the one or more news articles based on similarity of the data associated with the one or more news articles, using an artificial intelligence (AI) model. The

The plurality of subsystems further comprises a data categorizing subsystem configured to categorize the clustered data associated with the one or more news articles, into one or more pre-defined categories, using the AI model. The plurality of subsystems further comprises a data summarizing subsystem configured to summarize the categorized data associated with the one or more news articles by rephrasing and generating concise and coherent summaries of the categorized data associated with the one or more news articles, using the AI model. The plurality of subsystems further comprises an image generating subsystem configured to generate one or more images corresponding to the summarized data associated with the one or more news articles, using a stable diffusion model. The plurality of subsystems further comprises an output subsystem configured to provide the summarized data associated with the one or more news articles along with the corresponding one or more images, as an output, to one or more users through one or more user interfaces associated with one or more communication devices of the one or more users.

In another aspect, a non-transitory computer-readable storage medium having instructions stored therein that, when executed by a hardware processor, causes the processor to perform method steps as described above.

In yet another aspect, the AI-based system for generating a Non-Fungible Token (NFT) artworks from textual descriptions in the blockchain ecosystem. The AI-based system for generating the Non-Fungible Token (NFT) comprises the plurality of subsystems. The plurality of subsystems comprises a data obtaining subsystem, a non-fungible token (NFT) generating subsystem, and a non-fungible token (NFT) minting subsystem. The subsystems combine creativity, technology, and blockchain to empower the one or more users to create and monetize digital artworks in the form of NFTs. The AI-based system offers a wide range of options, from single NFT minting to creating and managing entire collections and supports multiple blockchain networks to make the process more user-friendly and accessible.

In yet another aspect, the AI-based system for analyzing digital asset valuation trends in the blockchain ecosystem. The AI-based system for analyzing digital asset valuation trends comprises the plurality of subsystems. The plurality of subsystems comprises a query obtaining subsystem, a query determining subsystem, an asset valuation trend analyzing subsystem, a real-time data updating subsystem, and an interaction generating subsystem. The AI-based system provides a powerful tool for tracking and understanding digital asset valuation trends. The AI-based system enables the users to make data-driven decisions in a dynamic and volatile platform, enabling the users to navigate the world of cryptocurrencies effectively.

In yet another aspect, the AI-based system for auditing digital contract securities in the blockchain ecosystem. The AI-based system for auditing digital contract securities comprises the plurality of subsystems. The plurality of subsystems comprises a digital contract code obtaining subsystem, a contract code analysis subsystem, a task decomposition subsystem, a contract code processing subsystem, and a report generating subsystem. The AI-based system is configured to assess the security of digital contracts, provide detailed audit reports, and ensure the integrity and trustworthiness of these contracts in a step-by-step process.

In yet another aspect, the AI-based system for generating digital contract code in the blockchain ecosystem. The AI-based system for generating digital contract code comprises the plurality of subsystems. The plurality of subsystems comprises a data receiving subsystem, a data pre-processing subsystem, a semantic analysis subsystem, an intent extraction subsystem, a solidity code generating subsystem, a code optimization subsystem, a code verification subsystem, and a data training subsystem. The AI-based system transforms natural language input into functional solidity code for digital contract development, with a strong emphasis on specialized training and user feedback for continual improvement.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture of an artificial intelligence (AI-based) system for optimizing a multi-faceted blockchain ecosystem, in accordance with an embodiment of the present disclosure;

FIG. 2A illustrates an overall architecture of the artificial intelligence (AI-based) system for generating one or more real-time news articles in a blockchain ecosystem, in accordance with an embodiment of the present disclosure;

FIG. 2B illustrates an exemplary block diagram representation of the AI-based system, such as those shown in FIG. 2A, capable of generating the one or more real-time news articles in the blockchain ecosystem, in accordance with an embodiment of the present disclosure;

FIG. 2C illustrates an exemplary flow chart representation of the AI-based system for generating one or more real-time news articles in the blockchain ecosystem, in accordance with an embodiment of the present disclosure;

FIG. 3A illustrates an overall architecture of the AI-based system for generating Non-Fungible Token (NFT) artworks from textual descriptions in the blockchain ecosystem, in accordance with an embodiment of the present disclosure;

FIG. 3B illustrates an exemplary block diagram representation of the AI-based system, such as those shown in FIG. 3A, capable of generating the NFT Artworks from the textual descriptions in the blockchain ecosystem, in accordance with an embodiment of the present disclosure;

FIG. 3C illustrates an exemplary flow chart representation of the AI-based system for generating the NFT Artworks from the textual descriptions in the blockchain ecosystem, in accordance with an embodiment of the present disclosure;

FIG. 4A illustrates an overall architecture of the AI-based system for analyzing digital asset valuation trends in the blockchain ecosystem, in accordance with an embodiment of the present disclosure;

FIG. 4B illustrates an exemplary block diagram representation of the AI-based system, such as those shown in FIG. 4A, capable of analyzing the digital asset valuation trends in the blockchain ecosystem, in accordance with an embodiment of the present disclosure;

FIG. 4C illustrates an exemplary flow chart representation of the AI-based system for analyzing the digital asset valuation trends in the blockchain ecosystem, in accordance with an embodiment of the present disclosure;

FIG. 5A illustrates an exemplary block diagram representation of the AI-based system, such as those shown in FIG. 1, capable of auditing digital contract securities in the blockchain ecosystem, in accordance with an embodiment of the present disclosure;

FIG. 5B illustrates an exemplary flow chart representation of the AI-based system for auditing digital contract securities in the blockchain ecosystem, in accordance with an embodiment of the present disclosure;

FIG. 6A illustrates an overall architecture of the AI-based system for generating digital contract code in the blockchain ecosystem, in accordance with an embodiment of the present disclosure;

FIG. 6B illustrates an exemplary block diagram representation of the AI-based system, such as those shown in FIG. 6A, capable of generating the digital contract code in the blockchain ecosystem, in accordance with an embodiment of the present disclosure;

FIG. 6C illustrates an exemplary flow chart representation of the AI-based system for generating the digital contract code in the blockchain ecosystem, in accordance with an embodiment of the present disclosure;

FIG. 6D illustrates an exemplary flow chart depicting the training pipeline for generating the digital contract code in the blockchain ecosystem, in accordance with an embodiment of the present disclosure;

FIG. 6E illustrates an process flow of the AI-based system for generating the digital contract code in the blockchain ecosystem, in accordance with an embodiment of the present disclosure; and

FIG. 7 is flow chart illustrating an artificial intelligence based (AI-based) method for generating the one or more real-time news articles in the blockchain ecosystem, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client, or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

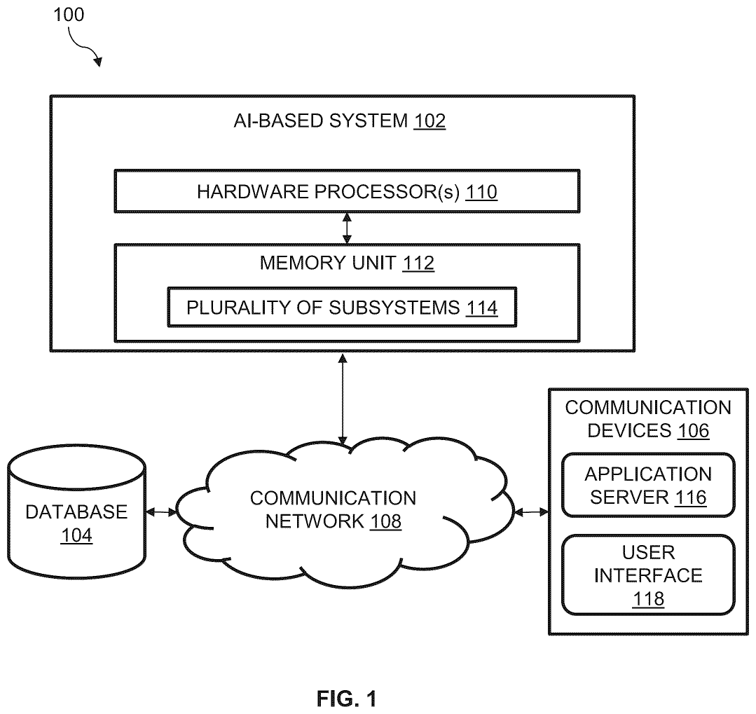

FIG. 1 illustrates an exemplary block diagram representation of a network architecture 100 of an artificial intelligence (AI-based) system 102 for optimizing a multi-faceted blockchain ecosystem, in accordance with an embodiment of the present disclosure. The terms AI-based system 102 and system may be used interchangeably.

According to an exemplary embodiment of the present disclosure, FIG. 1, the network architecture 100 may include the AI-based system 102, a database 104, and one or more communication devices 106. The AI-based system 102 may be communicatively coupled to the database 104, and the one or more communication devices 106 via the communication network 108. The communication network 108 may be a wired communication network and/or a wireless communication network. The database 104 may include, but is not limited to, storing, and managing data related to digital contracts, NFTs, cryptocurrency market information, user profiles, news articles, historical data, and the like. The database 104 may be any kind of database such as, but not limited to, relational databases, Non-relational databases, graph databases, document databases, dedicated databases, dynamic databases, monetized databases, scalable databases, cloud databases, distributed databases, any other databases, and a combination thereof. The database 104 is configured to support the functionality of the AI-based system 102 and enables efficient data retrieval and storage for various aspects associated with digital contracts, NFTs, cryptocurrency market information, user profiles, news articles, and historical trends.

In an exemplary embodiment, the one or more communication devices 106 serve as conduits for one or more users and one or more external systems to interact with the AI-based system 102, allowing for a wide range of access points and ensuring versatility in user engagement. The one or more communication devices 106 may be used to obtain input and/or receive output to/from the AI-based system 102, and/or to the database 104, respectively. The one or more communication devices 106 may be configured with an application server 116 and a user interface 118 to facilitate interactions with the AI-based system 102. These one or more communication devices 106 serve as gateways, allowing the one or more users to seamlessly engage with the AI-based system 102, query the database 104, and access various functionalities related to digital contracts, NFTs, cryptocurrency data, and news aggregation. The application servers and user interfaces enhance user experience and ensure smooth data exchange between the one or more users and the AI-based system 102. The one or more communication devices 106 may be at least one of, an electrical, an electronic, an electromechanical, and a computing device. The one or more communication devices 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, and the like.

Further, the AI-based system 102 may be implemented by way of a single device or a combination of multiple devices that may be operatively connected or networked together. The AI-based system 102 may be implemented in hardware or a suitable combination of hardware and software. The AI-based system 102 includes one or more hardware processors 110, and a memory unit 112. The memory unit 112 may include a plurality of subsystems 114. The AI-based system 102 may be a hardware device including the one or more hardware processors 110 executing machine-readable program instructions for dynamically recommending a course of action sequences to recommend a sequence of actions for various tasks or processes related to blockchain technology, such as digital contract development, NFT management, cryptocurrency trading, news aggregation and the like. Execution of the machine-readable program instructions by the one or more hardware processors 110 may enable the AI-based system 102 to dynamically recommend a course of action sequences to recommend a sequence of actions. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the AI-based system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. The person skilled in the art should not be limiting the components/subsystems shown in FIG. 1. Although FIG. 1 illustrates the AI-based system 102, and the one or more communication devices 106 connected to the database 104, one skilled in the art can envision that the AI-based system 102, and the one or more communication devices 106 may be connected to several user devices located at various locations and several databases 104 via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 102 as is unique to the present disclosure or necessary for an understanding of the present disclosure is depicted and described. The remainder of the construction and operation of the AI-based system 102 may conform to any of the various current implementations and practices that were known in the art.

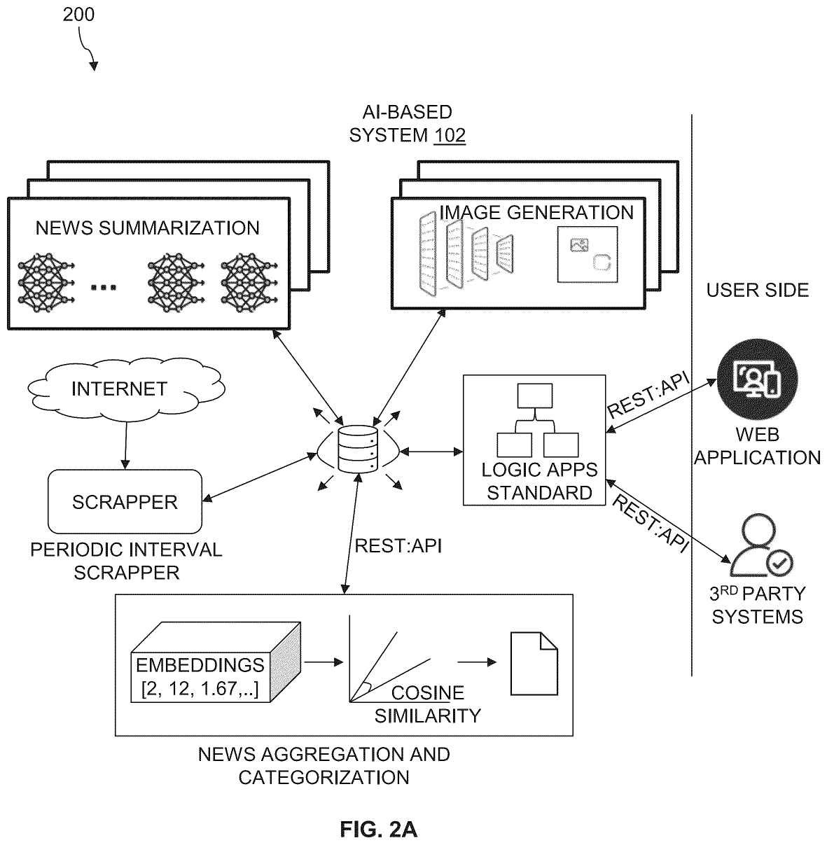

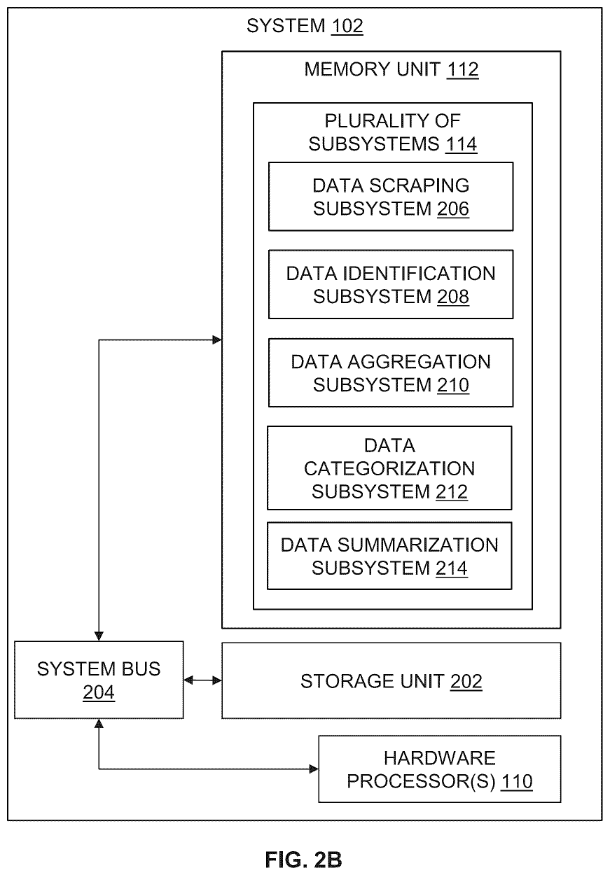

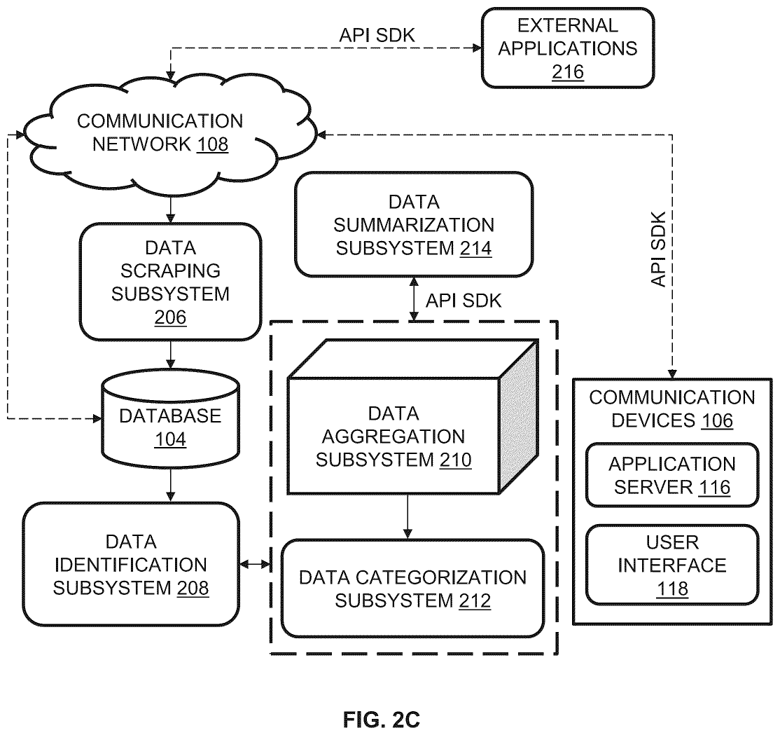

FIG. 2A illustrates an overall architecture of the AI-based system 102 for generating the one or more real-time news articles in the blockchain ecosystem, in accordance with an embodiment of the present disclosure. The AI-based system 102 is configured to periodically scrape the one or more news articles from various sources and websites related to cryptocurrencies, using a scraper. The scraping of the one or more news articles is performed in a pre-determined time interval to ensure the up-to-date information associated with the one or more news articles. The AI-based system 102 is configured to store the scraped data associated with the one or more news articles in a storage system (e.g., the database 104) using JavaScript Object Notation (JSON) files for efficient retrieval and processing.

The AI-based system 102 is configured to utilize an embedding model to generate one or more vector embeddings for each news article. The one or more vector embeddings are high-dimensional vectors (e.g., [2.12, 1.67, . . . ]) that capture the semantic meaning of the text. The AI-based system 102 is configured to compute cosine similarity between the embeddings of different news articles, using a cosine similarity function. The cosine similarity function allows the AI-based system 102 to identify similar or redundant news items across various sources. The cosine similarity function is configured to determine one or more similarity scores based on the determined one or more cosine similarities between the one or more vector embeddings generated for the data associated with the one or more news articles. The AI-based system 102 is configured to cluster related news article items and categorizes the related news articles into one or more predefined categories (e.g., “Bitcoin”, “DeFi”, “Regulatory News”), using AI model.

For categorizing the clustered data associated with the one or more news articles, into the one or more pre-defined categories, the AI model is configured to obtain the clustered data associated with the one or more news articles, from a data clustering subsystem. The AI model is further configured to compare one or more patterns of the clustered data associated with the one or more news articles with one or more pre-defined patterns of pre-defined data associated with one or more pre-defined news articles being stored in one or more databases. The AI model is further configured to categorizing, by the one or more hardware processors, the clustered data associated with the one or more news articles, into the one or more pre-defined categories upon comparison of the one or more patterns of the clustered data associated with the one or more news articles with the one or more pre-defined patterns of the pre-defined data associated with the one or more pre-defined news articles being stored in the database 104. The categorized news articles are stored in structured JSON file including aggregated and categorized news items, enabling efficient retrieval.

The AI-based system 102 is further configured to utilize a state-of-the-art Large Language Model (LLM) to rephrase and generate concise and coherent summaries of the aggregated news articles. The AI-based system 102 is further configured to generate one or more relevant images for news headlines, using an image generation model. The image generation model is configured to utilize a custom-trained Stable Diffusion model, specifically optimized for cryptocurrency-related imagery. The image generation model is trained on a large dataset of crypto-related images and corresponding text descriptions, enabling the image generation model to generate visually appealing and contextually appropriate images that complement the news summaries.

The AI-based system 102 is further configured to utilize the application server 116 for serving requests from a web application as well as other third party systems using an application programming interface software development kit (API SDK). The AI-based system 102 is further configured to utilize the user interface 118 to provide the complete front-end functionality to the one or more users. This functionality may be integrated with other websites using SDK.

FIG. 2B illustrates an exemplary block diagram representation of the AI-based system 102, such as those shown in FIG. 2A, capable of generating the one or more real-time news articles in the blockchain ecosystem, in accordance with an embodiment of the present disclosure.

FIG. 2C illustrates an exemplary flow chart representation of the AI-based system 102 for generating one or more real-time news articles in the blockchain ecosystem, in accordance with an embodiment of the present disclosure.

The AI-based system 102 comprises the one or more hardware processors 110, the memory unit 112, and a storage unit 204. The one or more hardware processors 110, the memory unit 112, and the storage unit 204 are communicatively coupled through a system bus 202 or any similar mechanism. The memory unit 112 is operatively coupled to the one or more hardware processors 110. The memory unit 112 comprises the plurality of subsystems 114 in the form of programmable instructions executable by the one or more hardware processors 110.

In an exemplary embodiment, the plurality of subsystems 114 comprises a data scraping subsystem 206, a data identification subsystem 208, a data aggregation subsystem 210, a data categorization subsystem 212, and a data summarization subsystem 214. The AI-based system 102 is configured to generate the one or more real-time news articles (i.e., one or more real-time news) to form a structured pipeline for collecting, processing, categorizing, and summarizing news data. The AI-based system 102 ensures that the one or more users receive relevant and concise news articles in real-time, enhancing their overall news consumption experience.

In an exemplary embodiment, the data scraping subsystem 206 is configured to collect the data associated with the one or more news articles from the various sources on a news publishing platform. The data scraping subsystem 206 is configured to use web scraping techniques to retrieve information from websites, blogs, and other online sources. The data scraping subsystem 206 is configured to collect the data associated with the one or more news articles at the pre-determined time intervals. Once the data associated with the one or more news articles are collected and stored in the database 104, the data identification subsystem 208 is configured to identify redundant or duplicate news articles from the data associated with the one or more news articles. The data identification subsystem 208 is configured with natural language processing (NLP) techniques to determine which data associated with the one or more news articles contain similar or identical information.

In an exemplary embodiment, the data aggregation subsystem 210 is configured to aggregate identical news articles together. This aggregation provides the one or more users with a consolidated view of specific topics or events, reducing clutter in the data associated with a news feed. The data categorization subsystem 212 is configured to categorize data associated with each news article of the one or more news articles into predefined categories by using NLP techniques. The data categorization subsystem 212 is configured to employ NLP techniques, such as text analysis and cosine similarity calculations, to determine which category each news article of the one or more news articles belongs to. Categorization assists users in easily finding news that aligns with their interests.

In an exemplary embodiment, the data summarization subsystem 214 is configured to generate concise summaries of data associated with each news article of the one or more news articles. The data summarization subsystem 214 is configured with Large Language Models (LLMs). The LLMs are configured to rephrase and summarize the content, making the data associated with each news article of the one or more news articles easier for users to grasp the main points and key takeaways from each news article of the one or more news articles. The application server 116 associated with the one or more communication devices 106 is responsible for serving the requests from the web application as well as other external applications 216 (i.e., the third-party systems) using the application programming interface software development kit (API SDK).

The technical advantages of the AI-based system 102 for generating real-time news include, but not limited to, effort reduction, efficient information retrieval, and enhanced clarity, highlighting each news article's value in providing streamlined and insightful news consumption for users interested in topics like crypto, AI, blockchain, web 3 and the like. By computerizing the process of discovering and generating up-to-date news, the AI-based system 102 significantly reduces the need for manual searching and content creation. This is especially valuable in fast-paced fields like cryptocurrency, artificial intelligence (AI), blockchain, and Web3, where staying informed is time-consuming. The one or more users are able to rely on the AI-based system 102 to curate and summarize relevant news articles, saving the users effort of sifting through numerous sources and articles. The AI-based system 102 may utilize the cutting-edge, state of the art tools and technologies to produce concise news summaries, offering a rapid and clear comprehension of complex concepts.

In the digital age, there's an overwhelming amount of online content, making the AI-based system 102 challenging to find the most pertinent and reliable information. The AI-based system 102 is configured to swiftly deliver pertinent details on specific subjects addressing this challenge effectively. Users can access concise and categorized news articles, assisting the users to keep up with the latest developments and trends in their areas of interest. The utilization of state-of-the-art tools and technologies, including the LLMs, for producing concise news summaries enhances clarity in news consumption. Complex concepts in fields like crypto, AI, blockchain, and web3 are able to be presented in a more understandable and digestible manner, allowing the one or more users to quickly grasp key insights without needing deep technical knowledge.

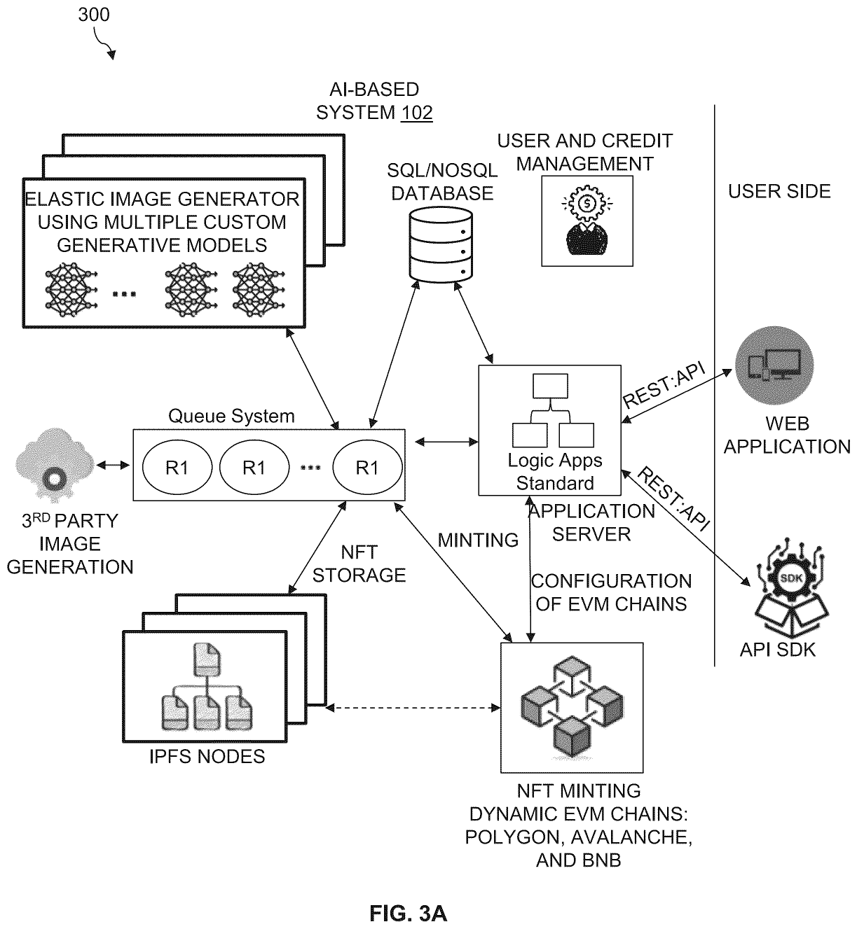

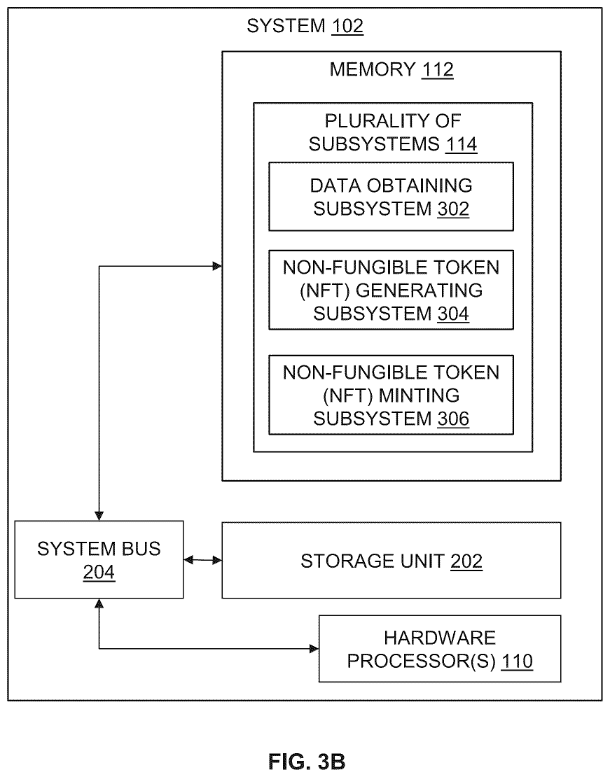

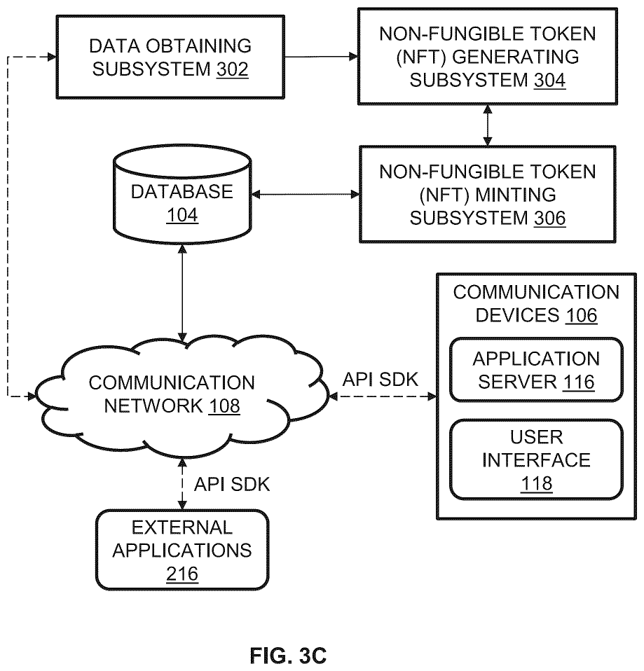

FIG. 3A illustrates an overall architecture of the AI-based system 102 for generating Non-Fungible Token (NFT) artworks from textual descriptions in the blockchain ecosystem, in accordance with an embodiment of the present disclosure. The AI-based system 102 includes an elastic image generator for generating one or more images from user-provided text descriptions using advanced computer vision and AI techniques. The AI-based system 102 is configured to utilize various versions of Stable Diffusion models, which have been fine-tuned to improve the quality of NFTs and offer one or more user options to generate images in different genres.

The AI-based system 102 further includes a third party generator to provide users with more variations of NFT images using third-party image generation AI models. The AI-based system 102 further includes a NFT minting that is configured with the NFT generator for managing the creation and minting of NFTs on various blockchains. A key feature of NFT minting is dynamic deployment (i.e., minting of NFTs) on any EVM compatible chain. The application server 116 allows the one or more users to integrate any EVM chains without needing to write code. The one or more users may add chain configurations through an admin interface, and the EVM chain may be integrated automatically.

The application server 116 is responsible for serving the requests from the web application as well as any other third party system using the API SDK. The application server 116 is further configured to manage user state and statistics for the leader board. The AI-based system 102 further includes a database that may include SQL and NoSQL databases. The database may be integrated with IPFS to store images generated by the image generation model. Specifically, the IPFS stores data related to users' NFT collections including at least one of: files, statistics, metadata for the NFTs, and the like. The AI-based system 102 further includes user and credit management system that is configured to manage the user authentication and verifies if the user is valid and have credits to use the services. The AI-based system 102 further includes a queue system configured to manage user requests for each collection of the NFT. The queue system is further configured to process the NFT generation and upload the images to the IPFS. The queuing system may help in scaling to accommodate a large number of the one or more users and image collections. For example, a user may generate multiple collections of up to 10,000 images at the same time. The user interface is configured to provide the complete front-end functionality to users. This functionality may be integrated with other websites using the SDK.

FIG. 3B illustrates an exemplary block diagram representation of the AI-based system 102, such as those shown in FIG. 3A, capable of generating the NFT Artworks from the textual descriptions in the blockchain ecosystem, in accordance with an embodiment of the present disclosure.

FIG. 3C illustrates an exemplary flow chart representation of the AI-based system 102 for generating the NFT Artworks from the textual descriptions in the blockchain ecosystem, in accordance with an embodiment of the present disclosure.

The AI-based system 102 comprises the one or more hardware processors 110, the memory unit 112, and the storage unit 204. The one or more hardware processors 110, the memory unit 112, and the storage unit 204 are communicatively coupled through the system bus 202 or any similar mechanism. The memory unit 112 is operatively coupled to the one or more hardware processors 110. The memory unit 112 comprises the plurality of subsystems 114 in the form of programmable instructions executable by the one or more hardware processors 110.

In an exemplary embodiment, the plurality of subsystems 114 comprises a data obtaining subsystem 302, a non-fungible token (NFT) generating subsystem 304, and a non-fungible token (NFT) minting subsystem 306. The plurality of subsystems 114 combine creativity, technology, and blockchain to empower the one or more users to create and monetize digital artworks in the form of NFTs. The AI-based system 102 offers a wide range of options, from single NFT minting to creating and managing entire collections and supports multiple blockchain networks to make the process more user-friendly and accessible.

In an exemplary embodiment, the data obtaining subsystem 302 is configured to obtain data associated with the digital artworks in the form of textual descriptions or prompts. The data obtaining subsystem 302 is configured to obtain the data from the user interface 118 associated with the one or more communication devices 106 by using the application programming interface software development kit (API SDK). The obtained data associated with the digital artworks is stored in the database 104.

In an exemplary embodiment, the non-fungible token (NFT) generating subsystem 304 is configured to generate the digital artworks by analyzing the data associated with the digital artworks. The data associated with the digital artworks in the form of textual descriptions or prompts are analyzed by at least one of: artificial intelligence (AI) algorithms and generative models to turn the textual description input into visual digital artworks.

In an exemplary embodiment, the non-fungible token (NFT) minting subsystem 306 is configured to allow the users to mint NFTs from the generated digital artworks. The NFTs are unique digital assets with ownership recorded on a blockchain. The non-fungible token (NFT) minting subsystem 306 is configured to allow the one or more users to mint both single NFTs and multiple NFTs (collections) based on the provided prompts or descriptions. The non-fungible token (NFT) minting subsystem 306 caters to individual the one or more users to create themed collections. The non-fungible token (NFT) minting subsystem 306 is configured with re-minting functionality that allows the one or more users to mint additional NFTs from their existing collections at a later time. This is useful for users who want to expand their collections or offer new variations.

One of the unique aspects of the non-fungible token (NFT) minting subsystem 306 is to support minting NFTs on various blockchain networks, including, but not limited to, Polygon, Avalanche, and Binance Smart Chain (BNB). This flexibility accommodates user preferences and blockchain ecosystem diversity. The non-fungible token (NFT) minting subsystem 306 is configured with an NFT leaderboard. The NFT leaderboard provides the one or more users with valuable insights into the NFT platform. Users are able to discover trending or high-value NFTs, obtain an understanding of which pieces are currently in demand, and access information about the collection of NFTs, floor prices, trading volume, and the like.

In an exemplary embodiment, the application server 116 serves as a core of the AI-based system 102, responsible for handling user requests and interactions. The application server 116 manages user states and statistics for the NFT leaderboard, providing users with insights into the NFT platform. The application server 116 provides a gateway for web applications and external applications 216 to interact with the system through an API SDK. The user interface 118 is configured to provide a frontend functionality for users to interact with the AI-based system 102. Users are able to input prompts, generate digital art, mint NFTs, explore the NFT marketplace, and access statistics through this user interface 118.

Numerous advantages of the present disclosure by providing the AI-based system 102 to create dynamic and interactive NFTs, which enhances user engagement. The AI-based system 102 introduces a whole new dimension to the world of digital art and NFTs. Dynamic NFTs may change over time, responding to various factors such as user interactions, external events, or even the passage of time itself. Interactive NFTs allow the one or more users to control certain aspects of the digital artwork, creating a more immersive and participatory experience.

The concept of personalized NFTs based on user preferences and textual descriptions is highly appealing to users who want to express their individuality through digital artwork. The AI-based system 102 is configured to generate one or more personalized NFTs based on user preferences and descriptions, and the AI-based system 102 is able to use the AI model to create NFTs tailored to their unique tastes. This personalization adds an emotional connection between users and their NFTs, potentially increasing the value of these digital assets to collectors. The AI-based system 102 is configured with the AI model to generate diverse and evolving art styles ensures that one or more users always have access to fresh and innovative content. The AI-based system 102 is adapted to change trends and user demands, keeping the NFT platforms vibrant and exciting.

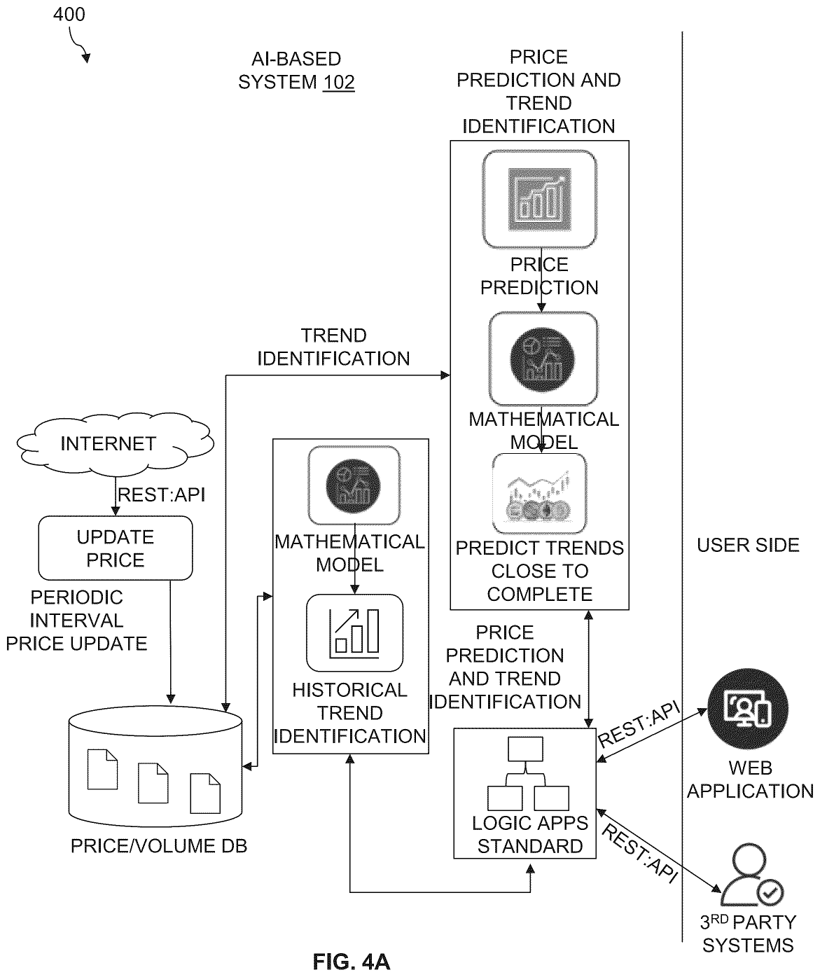

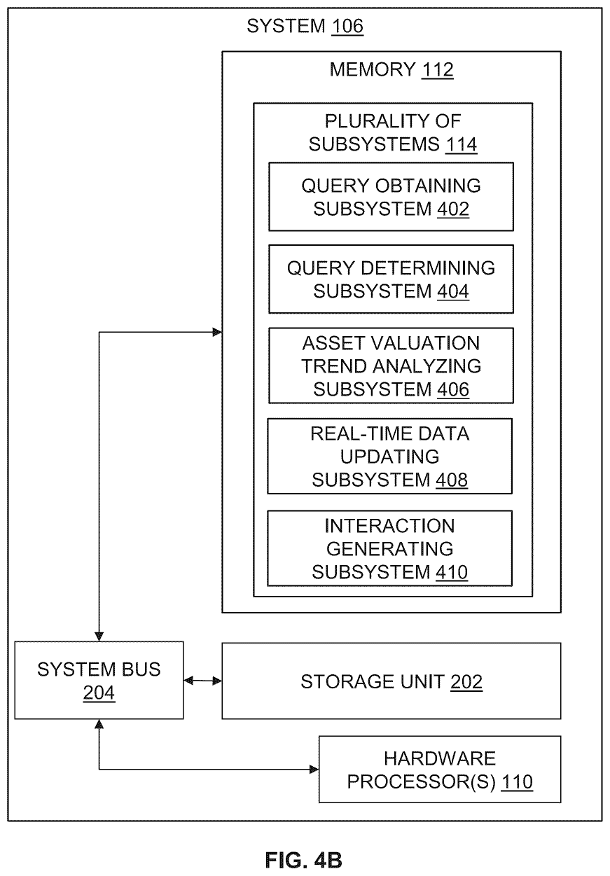

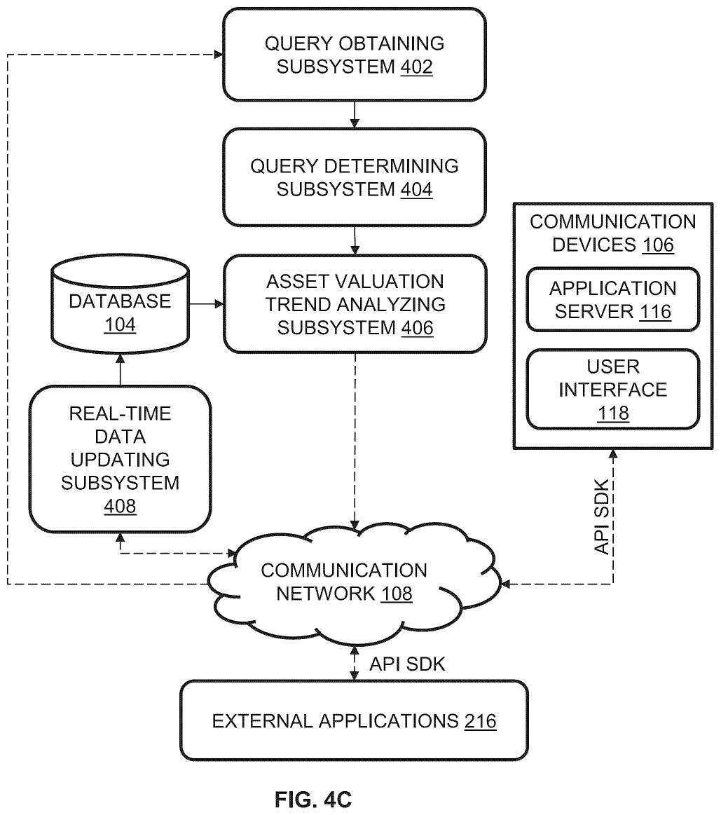

FIG. 4A illustrates an overall architecture of the AI-based system 102 for analyzing digital asset valuation trends in the blockchain ecosystem, in accordance with an embodiment of the present disclosure. The AI-based system 102 is initially configured to obtain price data of cryptocurrencies from coin markets using a price update model through REST APIs. The price update model is triggered periodically to fetch latest price information. In an embodiment, the price update model is configured to update the price data at a pre-determined time interval.

The AI-based system 102 includes a database storing historical price and volume data for various cryptocurrencies. The AI-based system 102 is further configured to retrieve and process cryptocurrency market data from the database to analyse, interpret, and present various trends, using a trend identification model. The trend identification model may include mathematical models that apply predefined heuristics to historical and predicted data in order to detect emerging trends. The trend identification model may further include pattern recognition models that identifies chart formations including wedge, cup and handle, head and shoulders, Wyckoff, Bart Simpson, and the like. In an embodiment, the patterns are analyzed and presented to the one or more users for further insights, helping the one or more users make informed trading decisions.

The trend identification model is configured to automate a traditionally complex process of trend identification, eliminating the need for the one or more users to understand technical details including at least one of: resistance levels, support lines, or intricate chart patterns. By integrating technical indicators including at least one of: moving averages, RSI (Relative Strength Index), and Bollinger Bands, the Trend Analyzer provides a comprehensive view of market movements. The indicators, combined with trend patterns, may enhance credibility of formations like wedge patterns or head & shoulders, providing the one or more users a clearer and more reliable basis for decision-making. Even the one or more users with technical expertise may make well-informed trading decisions without manually interpreting charts or understanding the underlying indicators.

The AI-based system 102 is further configured to utilize a price prediction model trained on cryptocurrency prices, utilizing historical data to identify future price movements. The price prediction model is trained on a diverse range of market histories (e.g., from coins with over five years of data to newer, more volatile assets with less than 1.5 years of data). The broad spectrum allows the price prediction model to capture established market trends for older coins while detecting rapid shifts for newer ones, ensuring accurate predictions across a wide range of cryptocurrencies, regardless of market maturity. Upon price prediction, the mathematical heuristics are applied to the predicted data to identify emerging trends. The AI-based system 102 evaluates the probability of near-term trend formations or reversals, based on both predicted price movements and historical patterns. By detecting trends before they fully develop, the price prediction model provides timely buy, sell, or hold recommendations.

The AI-based system 102 further includes the application server 116 for serving the requests from the web application as well as any other third party system using the API SDK. The application server 116 coordinates the flow of data between the trend identifier/analyzer, price predictor, and other modules to generate analyses of the digital asset valuation trends. The AI-based system 102 further includes the user interface 118 to display the coin market data, analyzed trends, and price predictions using an interactive chart.

FIG. 4B illustrates an exemplary block diagram representation of the AI-based system 102, such as those shown in FIG. 4A, capable of analyzing the digital asset valuation trends in the blockchain ecosystem, in accordance with an embodiment of the present disclosure.

FIG. 4C illustrates an exemplary flow chart representation of the AI-based system 102 for analyzing the digital asset valuation trends in the blockchain ecosystem, in accordance with an embodiment of the present disclosure.

The AI-based system 102 comprises the one or more hardware processors 110, the memory unit 112, and the storage unit 204. The one or more hardware processors 110, the memory unit 112, and the storage unit 204 are communicatively coupled through the system bus 202 or any similar mechanism. The memory unit 112 is operatively coupled to the one or more hardware processors 110. The memory unit 112 comprises the plurality of subsystems 114 in the form of programmable instructions executable by the one or more hardware processors 110.

In an exemplary embodiment, the plurality of subsystems 114 comprises a query obtaining subsystem 402, a query determining subsystem 404, an asset valuation trend analyzing subsystem 406, a real-time data updating subsystem 408, and an interaction generating subsystem 410. The AI-based system 102 provides a powerful tool for tracking and understanding digital asset valuation trends. The AI-based system 102 enables the users to make data-driven decisions in a dynamic and volatile platform, enabling the users to navigate the world of cryptocurrencies effectively.

In an exemplary embodiment, the query obtaining subsystem 402 is configured to obtain the one or more queries about the digital asset valuation trends including cryptocurrency price trends. The query obtaining subsystem 402 interacts with the one or more users to collect input from the one or more communication devices 106 to understand specific requests or questions of the users. The query determining subsystem 404 is configured to determine the purpose and context of the one or more queries. The query determining subsystem 404 employs Large Language Models (LLMs) to extract key information from the one or more queries, such as the digital asset of interest and the time frame for analysis.

In an exemplary embodiment, the asset valuation trend analyzing subsystem 406 is configured to analyze the asset valuation trends by comparing the determined one or more queries with historical digital asset price data. The asset valuation trend analyzing subsystem 406 employs the mathematical models to identify various trends, patterns, and anomalies in the price history of the assets. The asset valuation trend analyzing subsystem 406 provides users with actionable insights into digital asset valuation trends, supporting data-driven decision-making.

In an exemplary embodiment, the real-time data updating subsystem 408 is configured to ensure the analysis of the one or more queries is based on the most current data. The real-time data updating subsystem 408 periodically fetches and updates real-time digital asset price data from various sources and stores the real-time digital asset price data in the database 104. The real-time data updating subsystem 408 is configured to maintain the database 104 of up-to-date price information.

In an exemplary embodiment, the interaction generating subsystem 410 is configured to generate responses to the one or more users based on the analysis conducted by the asset valuation trend analyzing subsystem 406. The interaction generating subsystem 410 is configured to generate outputs to depict on the user interface 118 of the one or more communication devices 106 regarding the cryptocurrency data and analyzed asset valuation trend using an interactive chart. Offers a user-friendly interface for the one or more users to visualize and interpret trend analysis results. Enhances the overall user experience by providing a clear and intuitive presentation of data. The application server 116 is configured to provide the API SDK for the external applications 216 to interact with the AI-based system 102.

In an exemplary embodiment, the AI-based system 102 allows the one or more users including trading professionals to quickly access pertinent patterns and insights without the need for labor-intensive manual analysis. The AI-based system 102 is configured to automated the processes than the manual analysis, which is labour- and time-intensive. Traders are able to react swiftly to financial changes and opportunities, which is crucial in fast-moving financial platforms. The AI-based system 102 relies on data-driven algorithms, providing an objective analysis that is not influenced by subjective elements. Objectivity is especially important in trading, where emotions may lead to impulsive decisions and losses. Allowing the one or more users to create their prompts for analysis is a powerful feature. The AI-based system 102 enables the one or more users to tailor the analysis to their specific trading strategies and preferences. Leveraging historical data trends to guide trading decisions for enhancing the probability of profitable trades. The AI-based system 102 provides actionable insights based on historical data and empowers traders to make more informed and data-driven decisions. The AI-based system 102 is configured to analyze the near appearance or completion of trends based on predicted price points that offers a unique advantage in anticipating market shifts.

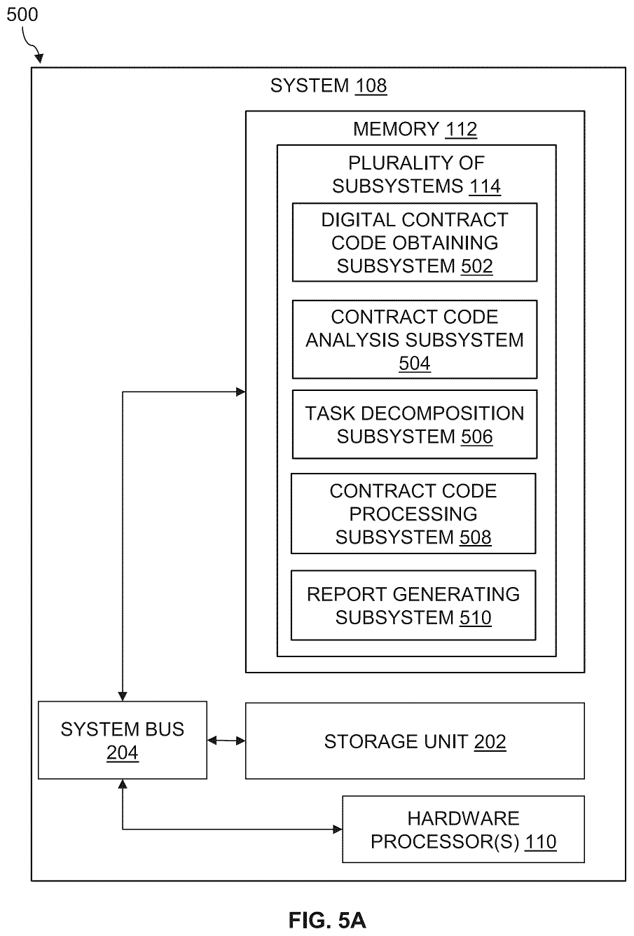

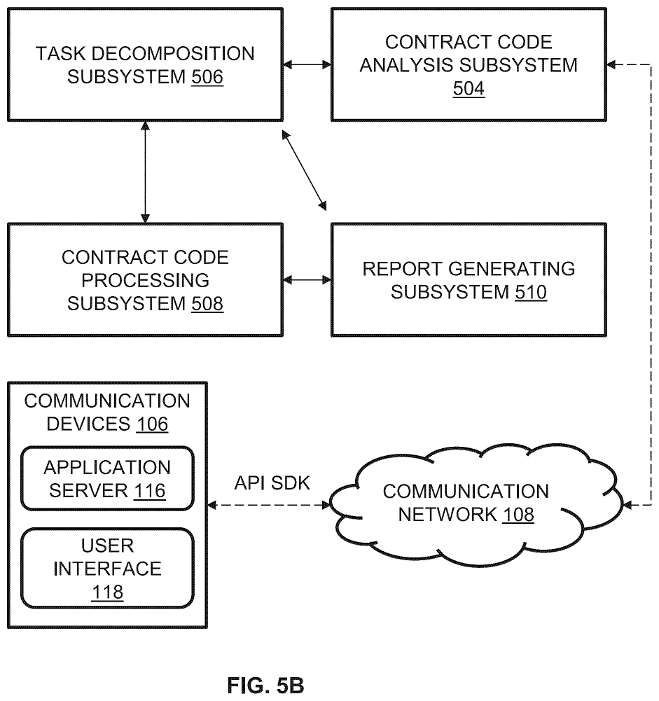

FIG. 5A illustrates an exemplary block diagram 500 representation of the AI-based system 102, such as those shown in FIG. 1, capable of auditing digital contract securities in the blockchain ecosystem, in accordance with an embodiment of the present disclosure.

FIG. 5B illustrates an exemplary flow chart representation of the AI-based system 102 for auditing digital contract securities in the blockchain ecosystem, in accordance with an embodiment of the present disclosure.

The AI-based system 102 comprises the one or more hardware processors 110, the memory unit 112, and the storage unit 204. The one or more hardware processors 110, the memory unit 112, and the storage unit 204 are communicatively coupled through the system bus 202 or any similar mechanism. The memory unit 112 is operatively coupled to the one or more hardware processors 110. The memory unit 112 comprises the plurality of subsystems 114 in the form of programmable instructions executable by the one or more hardware processors 110.

In an exemplary embodiment, the plurality of subsystems 114 comprises a digital contract code obtaining subsystem 502, a contract code analysis subsystem 504, a task decomposition subsystem 506, a contract code processing subsystem 508, and a report generating subsystem 510. The AI-based system 102 is configured to assess the security of digital contracts, provide detailed audit reports, and ensure the integrity and trustworthiness of these contracts in a step-by-step process.

In an exemplary embodiment, the digital contract code obtaining subsystem 502 is configured to obtain the digital contract codes as inputs to the AI-based system 102. The digital contract codes are essentially the computer programs that define the terms and conditions of a digital contract on the blockchain. The digital contract codes contain instructions that the AI-based system 102 assesses for security, correctness, and compliance.

In an exemplary embodiment, the contract code analysis subsystem 504 is configured to analyze the obtained digital contract codes without executing to identify static properties of the digital contract codes. The static properties such as control flow and structure. The contract code analysis subsystem 504 is configured with predefined algorithms to search for known vulnerabilities and issues within the digital contract code. The contract code analysis subsystem 504 ensures the digital contract code adheres to specified standards and security best practices.

In an exemplary embodiment, the task decomposition subsystem 506 is configured to receive the outputs from the contract code analysis subsystem 504. The task decomposition subsystem 506 is configured to device the digital contract code into smaller, manageable steps. The task decomposition subsystem 506 is configured to create specific tasks for each step of the auditing process based on the characteristics of the digital contract code and potential vulnerabilities.

In an exemplary embodiment, the contract code processing subsystem 508 is configured to receive the prompts generated by the task decomposition subsystem 506. The contract code processing subsystem 508 is configured with large language models (LLMs) to process the prompts and process the digital contract code. The contract code processing subsystem 508 is configured to summarize the findings and responses obtained from the LLMs for each auditing step. The digital contract code processing subsystem 508 is configured to validate the digital contract code against optimal practices and security standards and identify any issues or vulnerabilities.

In an exemplary embodiment, the report generating subsystem 510 is configured to gather the summarized findings and responses from the LLM analysis. The report generating subsystem 510 is configured to compile a comprehensive audit report that includes: a summary of the contract structures and purpose, details of any vulnerabilities or issues found, recommendations for addressing identified problems, and compliance with security standards and best practices. The report comprises visual aids such as diagrams or graphs to assist users in understanding the audit results.

In an exemplary embodiment, the application server 116 is configured to request from the web application or external applications 216 via an API. The application server 116 is configured to establish communication between the user interface 118 and the auditing modules. The application server 116 is configured to deliver the audit report and findings to the user interface 118 or requesting AI-based system 102. The record and maintain logs of auditing requests and responses for traceability and future reference.

In an exemplary embodiment, the AI-based system 102 conducts a detailed and comprehensive examination of the digital contract code, which means the AI-based system 102 is able to identify even the smallest flaws or vulnerabilities. This thoroughness is essential for ensuring the digital contract security and reliability. Unlike manual audits, which are time-consuming and prone to human error, the digital contract auditor computerizes the auditing process. This computerization not only saves time but also ensures that the audit is consistently thorough and complete. By computerizing the auditing process, the AI-based system 102 eliminates the need to hire professional human auditors for routine or repetitive tasks. This results in significant cost savings for organizations that frequently use digital contracts, as they no longer need to allocate resources for manual audits.

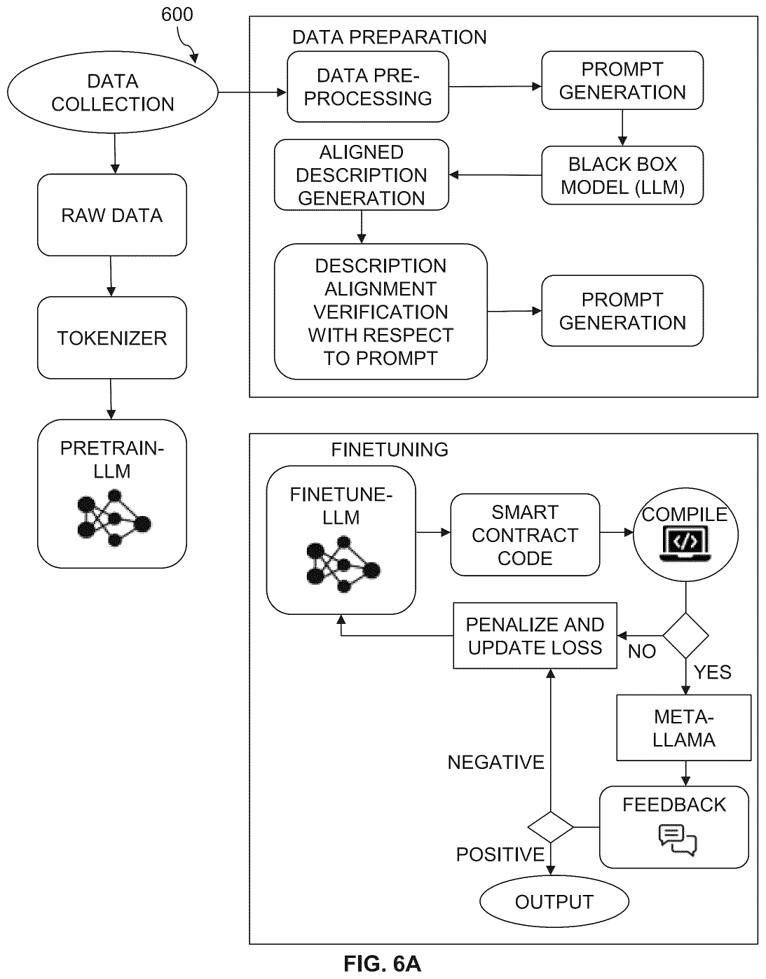

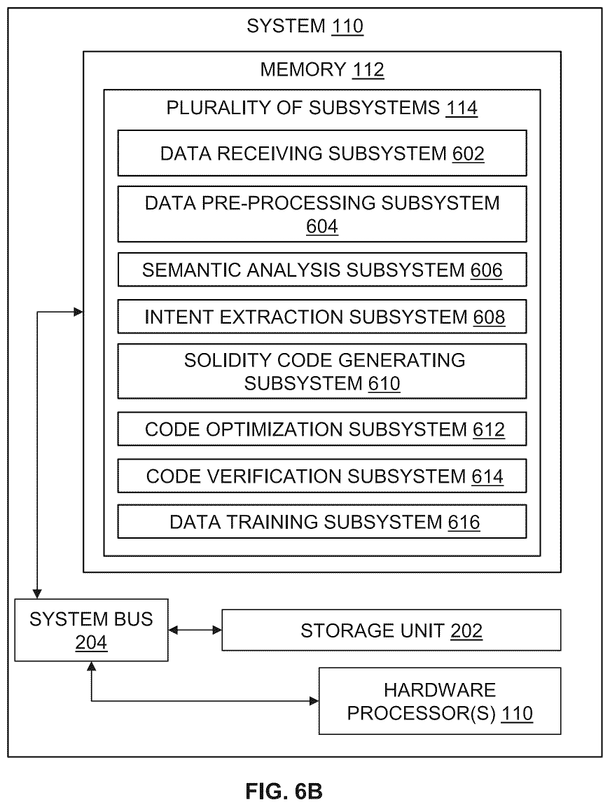

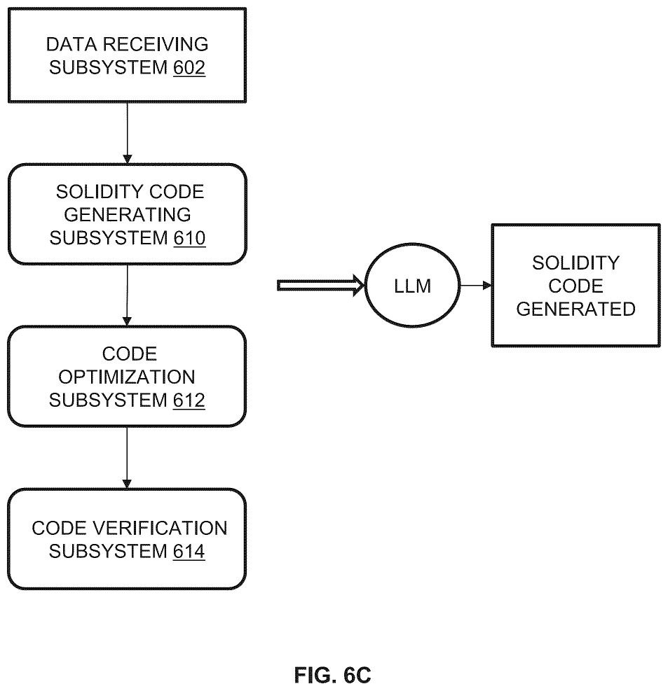

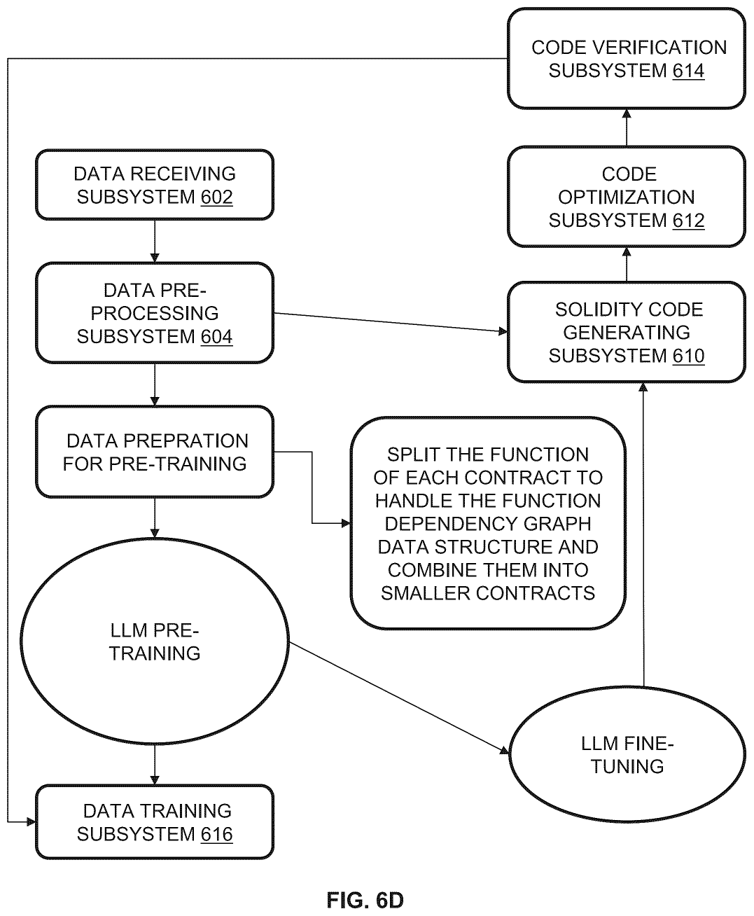

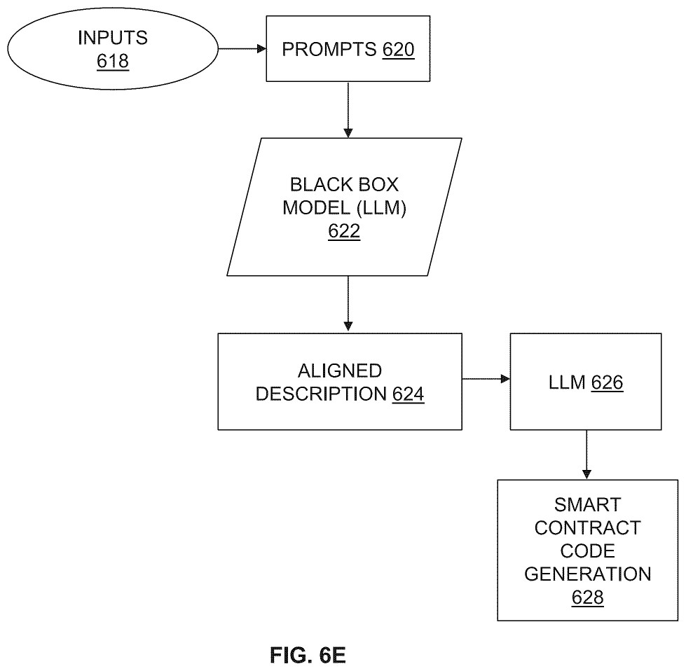

FIG. 6A illustrates an overall architecture 600 of the AI-based system 102 for generating digital contract code in the blockchain ecosystem, such as shown in FIG. 1, in accordance with an embodiment of the present disclosure. The AI-based system 102 is configured to collect a diverse data associated with a smart contract code from open-source platforms to utilize web crawling techniques to enhance training data. The AI-based system 102 is configured to ingest the raw data into the AI model in form of smart contracts code, book chapters and solidity documentation, in order to pre-train the Large Language Model (LLM). The AI-based system 102 is configured to transform the raw text into structured data that may be easily fed to the AI model, using a tokenizer. The AI model processes the text into tokens, maps those tokens to IDs, and prepares the data for subsequent tasks like embedding and attention. The AI-based system 102 is configured to pre-train the AI model with tokenized dataset including billions of tokens.

The collected data are preprocessed, where the collected data are formatted and structured appropriately. In an embodiment, prompts are generated against this data and ingested the data to an open-source model (i.e., a Blackbox model) tasked with creating the detailed descriptions for each data point. Further, the data including smart contracts, and their descriptions generated by the Black Box model are processed to ensure quality and relevance. During the process, a Large Language Model (LLM) is configured to check if the description includes all aspects of the smart contract, including at least one of: interfaces, functions, and logic. Additionally, the smart contract code is checked for compilation and other errors. Once verified, this data is suitable for fine-tuning the LLM.

The AI-based system 102 is configured to fine-tine the LLM with the prepared dataset. During the fine-tuning process, the AI-based system 102 is configured to evaluate and improve the performance of the fine-tuned AI model by generating smart contracts (i.e., various categories and use cases, e.g., ERC20, ORACLES, DAO, Defi, and the like) and attempting to compile and deploy the fine-tuned AI model. The AI-based system 102 is configured to utilize a feedback loop for fine-tuning the AI model. If the generated smart contract code compiles successfully, the smart contract code is further assessed by the Meta-Llama model for feedback. In an embodiment, A positive response from Meta-Llama may trigger the generation of a final response. Conversely, if the smart contract code does not compile and the feedback is negative, a penalty may be applied. This feedback process may involve updating the loss accordingly, which prompts the AI model to continue generating embeddings until the AI model successfully produces improved responses. Throughout the iterative process, the AI model learns to refine its outputs, ensuring higher quality and reliability in the generated smart contracts.

FIG. 6B illustrates an exemplary block diagram representation of the AI-based system 102, such as those shown in FIG. 6A, capable of generating the digital contract code in the blockchain ecosystem, in accordance with an embodiment of the present disclosure.

FIG. 6C illustrates an exemplary flow chart representation of the AI-based system 102 for generating the digital contract code in the blockchain ecosystem, in accordance with an embodiment of the present disclosure.

FIG. 6D illustrates an exemplary flow chart depicting the training pipeline for generating the digital contract code in the blockchain ecosystem, in accordance with an embodiment of the present disclosure.

The AI-based system 102 comprises the one or more hardware processors 110, the memory unit 112, and the storage unit 204. The one or more hardware processors 110, the memory unit 112, and the storage unit 204 are communicatively coupled through the system bus 202 or any similar mechanism. The memory unit 112 is operatively coupled to the one or more hardware processors 110. The memory unit 112 comprises the plurality of subsystems 114 in the form of programmable instructions executable by the one or more hardware processors 110.

In an exemplary embodiment, the plurality of subsystems 114 comprises a data receiving subsystem 602, a data pre-processing subsystem 604, a semantic analysis subsystem 606, an intent extraction subsystem 608, a solidity code generating subsystem 610, a code optimization subsystem 612, a code verification subsystem 614, a data training subsystem 616. The AI-based system 102 transforms natural language input into functional solidity code for digital contract development, with a strong emphasis on specialized training and user feedback for continual improvement.

In an exemplary embodiment, the data receiving subsystem 602 is configured to receive data associated with one or more parameters, one or more requirements, and one or more specifications of the digital contract to be developed. The data encompass a wide range of details including, but not limited to, at least one of: a contract type, conditions, parties involved, transaction mechanisms, and any additional features or functionalities desired by the one or more users or originating from external data feeds. The data receiving subsystem 602 is configured to initiate the digital contract development process by collecting all the necessary input data for the subsequent stages of analysis and code generation.

In an exemplary embodiment, the data pre-processing subsystem 604 is responsible for refining and structuring the information received by the data receiving subsystem 602. The data pre-processing subsystem 604 may involve tasks such as tokenization, natural language parsing, and data cleaning to ensure that the received data is in a suitable format for further analysis by the AI-based system 102. The data pre-processing subsystem 604 is configured to prepare the raw received data for subsequent stages, where the data is analyzed and transformed into actionable insights for the digital contract code generation process.

In an exemplary embodiment, the semantic analysis subsystem 606 is configured to extract an underlying meaning, intent, and relevant details from the pre-processed data provided by the data pre-processing subsystem 604. This subsystem employs advanced Large Language Models (LLMs), including semantic parsing and entity recognition, to understand the user's or external source's requirements and objectives in the context of digital contract development. By discerning the semantics of the received data, the semantic analysis subsystem 606 facilitates the subsequent stages of code synthesis by identifying key intents, actions, parameters, and relationships crucial for generating the appropriate digital contract code.

In an exemplary embodiment, the intent extraction subsystem 608 operates in tandem with the semantic analysis subsystem 606 and is dedicated to the precise extraction of the user's or external source's intent and specific requirements from the semantically analyzed data. This intent extraction subsystem 608 identifies and isolates the essential actions, commands, and conditions implied by the received data, allowing for an unambiguous understanding of what the digital contract should accomplish. By extracting these intents and requirements, the intent extraction subsystem 608 provides a foundation for the subsequent module responsible for the generation of Solidity code, ensuring that the resulting code aligns accurately with the user's or external source's objectives.

In an exemplary embodiment, the solidity code generating subsystem 610 is a pivotal component of the AI-based system 102, tasked with translating the extracted user intents, requirements, and specifications into functional Solidity code for digital contract development. Leveraging specialized algorithms, templates, and domain-specific knowledge, this solidity code generating subsystem 610 meticulously constructs the necessary code structures, functions, and logic to create the digital contract codes that aligns precisely with the users or external sources described objectives. The solidity code generating subsystem 610 ensures that the generated code is not only syntactically correct but also adheres to unsurpassed practices and security standards in Solidity development, ultimately producing a robust and reliable digital contract ready for deployment on a blockchain network.

In an exemplary embodiment, the code optimization subsystem 612 operates downstream of the solidity code generating subsystem 610 and is dedicated to enhancing the efficiency, performance, and security of the generated digital contract code. The code optimization subsystem 612 utilizes various optimization techniques in Solidity development to refine the code further. The code optimization subsystem 612 may include tasks such as gas cost reduction, elimination of redundant functions or variables, and the implementation of code patterns that improve execution speed. The code optimization subsystem 612 ensures that the generated code not only meets the user's requirements but also operates optimally on the chosen blockchain network, resulting in a digital contract that is both reliable and cost-effective to deploy and execute.

In an exemplary embodiment, the code verification subsystem 614 serves as a critical quality assurance component within the AI-based system 102. Following the generation and optimization of the digital contract code, the code verification subsystem 614 is responsible for rigorously validating the code to identify potential vulnerabilities, errors, or security risks. The code verification subsystem 614 conducts comprehensive static analysis and automated testing procedures to ensure that the generated code complies with established coding standards, security protocols, and blockchain-specific best practices. By conducting such thorough verification, the code verification subsystem 614 is configured to enhance the security and reliability of the generated digital contract, reducing the likelihood of vulnerabilities that could be exploited on the blockchain network.

In an exemplary embodiment, the data training subsystem 616 plays a fundamental role in the AI-based system's 102 continual improvement and adaptation. The data training subsystem 616 is responsible for the selection and preparation of relevant training data used to enhance the capabilities of the specialized language model employed by the AI-based system 102. The data training subsystem 616 is configured to carefully curate a diverse dataset that includes digital contract source code examples, use cases, and blockchain-specific information. The data training subsystem 616 conducts fine-tuning and retraining processes on the language model, ensuring that data training subsystem 616 remains aligned with the latest trends, standards, and nuances in digital contract development. By continually updating and refining the LLMs, this data training subsystem 616 enables the AI-based system 102 to stay responsive to evolving user needs and emerging blockchain technologies, thereby maintaining the AI-based system 102 effectiveness and accuracy in generating Solidity code from natural language prompts.

The AI-based system 102 focuses on addressing the unique requirements of blockchain applications, which sets the AI-based system 102 apart from generalized text-to-code models. The AI-based system 102 architecture is specialized for generating digital contract code, ensuring that the resulting code is tailored to the needs of blockchain development. The AI-based system 102 is trained on a substantial amount of relevant data, including more than 3 billion tokens. This training data is specific to blockchain applications, enhancing the understanding and accuracy of the AI-based system 102. As a result of the AI-based system 102 specialization and training, the invention generates digital contracts faster and with greater accuracy compared to previous text-to-code models. The AI-based system 102 proposes a user-friendly approach that allows individuals with no prior blockchain coding experience to contribute innovative ideas to the world of digital contracts. Automatic code generation significantly reduces development time, streamlining the digital contract development process.

FIG. 6E illustrates an process flow of the AI-based system 102 for generating the digital contract code in the blockchain ecosystem, in accordance with an embodiment of the present disclosure. At step 618, the inputs including the data associated with a smart contract code are collected from open-source platforms. At step 620, the prompts are generated against the data and ingested the data to an open-source model (i.e., a Blackbox model), as shown in step 622. At step 624, the detailed and aligned descriptions are generated for each data point. At step 626, The LLM is configured to determine whether the description includes all aspects of the smart contract, including at least one of: interfaces, functions, and logic. At step 628, the smart contract code is generated and checked for compilation and other errors.

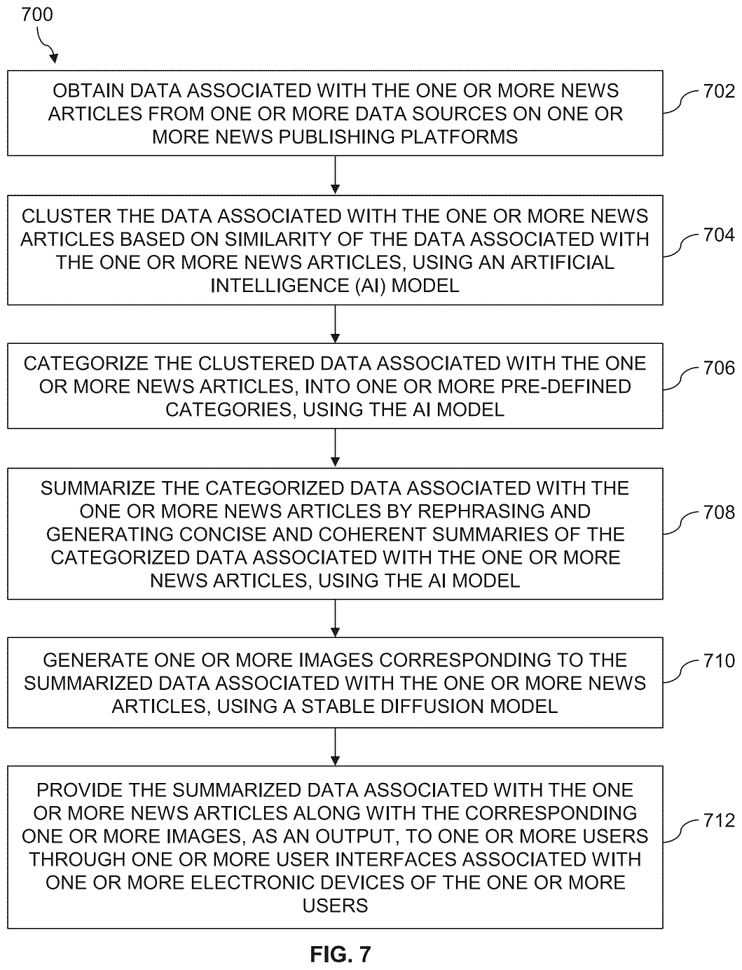

FIG. 7 is flow chart illustrating an artificial intelligence based (AI-based) method 700 for generating the one or more real-time news articles in the blockchain ecosystem, in accordance with an embodiment of the present disclosure. At step 702, the data associated with the one or more news articles are obtained from the one or more data sources on the one or more news publishing platforms. At step 704, the data associated with the one or more news articles are clustered based on similarity of the data associated with the one or more news articles, using the artificial intelligence (AI) model.

At step 706, the clustered data associated with the one or more news articles, are categorized into one or more pre-defined categories, using the AI model. At step 708, the categorized data associated with the one or more news articles are summarized by rephrasing and generating concise and coherent summaries of the categorized data associated with the one or more news articles, using the AI model. At step 710, the one or more images corresponding to the summarized data associated with the one or more news articles, are generated using a stable diffusion model. At step 712, the summarized data associated with the one or more news articles along with the corresponding one or more images, are provided as the output, to the one or more users through the one or more user interfaces 118 associated with one or more communication devices 106 of the one or more users.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based system 102 either directly or through intervening I/O controllers. Network adapters may also be coupled to the AI-based system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based system 102 in accordance with the embodiments herein. The AI-based system 102 herein comprises at least one processor or central processing unit (CPU). The CPUs are interconnected via the system bus 204 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based system 102. The AI-based system 102 can read the inventive instructions on the program storage devices and follow these instructions to execute the methodology of the embodiments herein.

The AI-based system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence based (AI-based) method for generating one or more news articles in a blockchain ecosystem, the AI-based method comprising:
obtaining, by one or more hardware processors, data associated with the one or more news articles from one or more data sources on one or more news publishing platforms;
clustering, by the one or more hardware processors, the data associated with the one or more news articles based on similarity of the data associated with the one or more news articles, using an artificial intelligence (AI) model;
categorizing, by the one or more hardware processors, the clustered data associated with the one or more news articles, into one or more pre-defined categories, using the AI model;
summarizing, by the one or more hardware processors, the categorized data associated with the one or more news articles by rephrasing and generating concise and coherent summaries of the categorized data associated with the one or more news articles, using the AI model;
generating, by the one or more hardware processors, one or more images corresponding to the summarized data associated with the one or more news articles, using a stable diffusion model; and
providing, by the one or more hardware processors, the summarized data associated with the one or more news articles along with the corresponding one or more images, as an output, to one or more users through one or more user interfaces associated with one or more communication devices of the one or more users.

2. The AI-based method of claim 1, wherein clustering the data associated with the one or more news articles based on the similarity of the data associated with the one or more news articles, comprises:
obtaining, by the one or more hardware processors, the data associated with the one or more news articles from a data scraping subsystem;
generating, by the one or more hardware processors, one or more vector embeddings for the data associated with each news article of the one or more news articles, using an embedding model, wherein the one or more vector embeddings are configured to determine one or more semantic meanings of one or more texts associated with the one or more news articles;
determining, by the one or more hardware processors, one or more cosine similarities between the one or more vector embeddings generated for the data associated with the one or more news articles, using a cosine similarity model;
determining, by the one or more hardware processors, one or more similarity scores based on the determined one or more cosine similarities between the one or more vector embeddings generated for the data associated with the one or more news articles; and
clustering, by the one or more hardware processors, the data associated with the one or more news articles based on the one or more similarity scores.

3. The AI-based method of claim 1, wherein categorizing the clustered data associated with the one or more news articles, into the one or more pre-defined categories, using the AI model, comprises:
obtaining, by the one or more hardware processors, the clustered data associated with the one or more news articles, from a data clustering subsystem;
comparing, by the one or more hardware processors, one or more patterns of the clustered data associated with the one or more news articles with one or more pre-defined patterns of pre-defined data associated with one or more pre-defined news articles being stored in one or more databases, using the AI model; and
categorizing, by the one or more hardware processors, the clustered data associated with the one or more news articles, into the one or more pre-defined categories upon comparison of the one or more patterns of the clustered data associated with the one or more news articles with the one or more pre-defined patterns of the pre-defined data associated with the one or more pre-defined news articles being stored in one or more databases.

4. The AI-based method of claim 1, further comprising:
training, by the one or more hardware processors, the stable diffusion model on one or more training datasets, wherein the one or more training datasets comprise at least one of: one or more crypto-related images and one or more text descriptions corresponding to the one or more crypto-related images; and
generating, by the one or more hardware processors, the one or more images corresponding to the summarized data associated with the one or more news articles, based on the trained stable diffusion model.

5. An artificial intelligence based (AI-based) system for generating one or more news articles in a blockchain ecosystem, the AI-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data scraping subsystem configured to obtain data associated with the one or more news articles from one or more data sources on one or more news publishing platforms;
a data clustering subsystem configured to cluster the data associated with the one or more news articles based on similarity of the data associated with the one or more news articles, using an artificial intelligence (AI) model;
a data categorizing subsystem configured to categorize the clustered data associated with the one or more news articles, into one or more pre-defined categories, using the AI model;
a data summarizing subsystem configured to summarize the categorized data associated with the one or more news articles by rephrasing and generating concise and coherent summaries of the categorized data associated with the one or more news articles, using the AI model;
an image generating subsystem configured to generate one or more images corresponding to the summarized data associated with the one or more news articles, using a stable diffusion model; and
an output subsystem configured to provide the summarized data associated with the one or more news articles along with the corresponding one or more images, as an output, to one or more users through one or more user interfaces associated with one or more communication devices of the one or more users.

6. The AI-based system of claim 5, wherein in clustering the data associated with the one or more news articles based on the similarity of the data associated with the one or more news articles, the data clustering subsystem is configured to:
obtain the data associated with the one or more news articles from a data scraping subsystem;
generate one or more vector embeddings for the data associated with each news article of the one or more news articles, using an embedding model, wherein the one or more vector embeddings are configured to determine one or more semantic meanings of one or more texts associated with the one or more news articles;
determine one or more cosine similarities between the one or more vector embeddings generated for the data associated with the one or more news articles, using a cosine similarity model;
determine one or more similarity scores based on the determined one or more cosine similarities between the one or more vector embeddings generated for the data associated with the one or more news articles; and
cluster the data associated with the one or more news articles based on the one or more similarity scores.

7. The AI-based system of claim 5, wherein in categorizing the clustered data associated with the one or more news articles, into the one or more pre-defined categories, using the AI model, the data categorizing subsystem is configured to:
obtain the clustered data associated with the one or more news articles, from a data clustering subsystem;
compare one or more patterns of the clustered data associated with the one or more news articles with one or more pre-defined patterns of pre-defined data associated with one or more pre-defined news articles being stored in one or more databases, using the AI model; and
categorize the clustered data associated with the one or more news articles, into the one or more pre-defined categories upon comparison of the one or more patterns of the clustered data associated with the one or more news articles with the one or more pre-defined patterns of the pre-defined data associated with the one or more pre-defined news articles being stored in one or more databases.

8. The AI-based system of claim 5, further comprising:
a training subsystem configured to train the stable diffusion model on one or more training datasets, wherein the one or more training datasets comprise at least one of: one or more crypto-related images and one or more text descriptions corresponding to the one or more crypto-related images; and
the image generating subsystem configured to generate the one or more images corresponding to the summarized data associated with the one or more news articles, based on the trained stable diffusion model.

9. A non-transitory computer-readable storage medium having instructions stored therein that when executed by one or more hardware processors, cause the one or more hardware processors to execute operations of:
obtaining data associated with the one or more news articles from one or more data sources on one or more news publishing platforms;
clustering the data associated with the one or more news articles based on similarity of the data associated with the one or more news articles, using an artificial intelligence (AI) model;
categorizing the clustered data associated with the one or more news articles, into one or more pre-defined categories, using the AI model;
summarizing the categorized data associated with the one or more news articles by rephrasing and generating concise and coherent summaries of the categorized data associated with the one or more news articles, using the AI model;
generating one or more images corresponding to the summarized data associated with the one or more news articles, using a stable diffusion model; and
providing the summarized data associated with the one or more news articles along with the corresponding one or more images, as an output, to one or more users through one or more user interfaces associated with one or more communication devices of the one or more users.

10. The non-transitory computer-readable storage medium of claim 9, wherein clustering the data associated with the one or more news articles based on the similarity of the data associated with the one or more news articles, comprises:
obtaining the data associated with the one or more news articles from a data scraping subsystem;
generating one or more vector embeddings for the data associated with each news article of the one or more news articles, using an embedding model, wherein the one or more vector embeddings are configured to determine one or more semantic meanings of one or more texts associated with the one or more news articles;
determining one or more cosine similarities between the one or more vector embeddings generated for the data associated with the one or more news articles, using a cosine similarity model;
determining one or more similarity scores based on the determined one or more cosine similarities between the one or more vector embeddings generated for the data associated with the one or more news articles; and
clustering the data associated with the one or more news articles based on the one or more similarity scores.

11. The non-transitory computer-readable storage medium of claim 9, wherein categorizing the clustered data associated with the one or more news articles, into the one or more pre-defined categories, using the AI model, comprises:
obtaining the clustered data associated with the one or more news articles, from a data clustering subsystem;
comparing one or more patterns of the clustered data associated with the one or more news articles with one or more pre-defined patterns of pre-defined data associated with one or more pre-defined news articles being stored in one or more databases, using the AI model; and
categorizing the clustered data associated with the one or more news articles, into the one or more pre-defined categories upon comparison of the one or more patterns of the clustered data associated with the one or more news articles with the one or more pre-defined patterns of the pre-defined data associated with the one or more pre-defined news articles being stored in one or more databases.

12. The non-transitory computer-readable storage medium of claim 9, further comprising:
training the stable diffusion model on one or more training datasets, wherein the one or more training datasets comprise at least one of: one or more crypto-related images and one or more text descriptions corresponding to the one or more crypto-related images; and
generating the one or more images corresponding to the summarized data associated with the one or more news articles, based on the trained stable diffusion model.
